(19) United States
(12) Patent Application Publication
(10) Pub. No.: US 2026/0071479 A1
(43) Pub. Date: Mar. 12, 2026

(54) SHIM ASSEMBLIES AND RELATED WINDOWS AND DOORS

(71) Applicant: Frank Joseph Tortorella, JR., Park Ridge, IL (US)

(72) Inventor: Frank Joseph Tortorella, JR., Park Ridge, IL (US)

(21) Appl. No.: 19/295,377

(22) Filed: Aug. 8, 2025

Related U.S. Application Data
(60) Provisional application No. 63/683,695, filed on Aug. 15, 2024.
(60) Provisional application No. 63/766,822, filed on Mar. 4, 2025.

(51) Int. Cl. E06B 1/60

(52) U.S. Cl. CPC E06B 1/6076

(57) ABSTRACT

Shim assemblies and related windows and doors are disclosed. An apparatus includes a shim assembly including a first plate and a second plate movably coupled together, and a wedge assembly. Each of the first plate and the second plate includes a first end including a first inward tapered surface and a second end including a second inward tapered surface. A wedge assembly includes a first wedge engaging the first inward tapered surfaces of the first plate and the second plate, a second wedge engaging the second inward tapered surfaces of the first plate and the second plate, and a fastener passing through the first wedge, between the first plate and the second plate, and threadably engaging the second wedge. Rotating the fastener changes a distance between the first wedge and the second wedge and changes a distance between the first plate and the second plate.

### RELATED APPLICATION SECTION

This application claims the benefit of and priority to U.S. Provisional Patent Application Number 63/683,695, filed Aug. 15, 2024, and U.S. Provisional Patent Application Number 63/766,822, filed Mar. 4, 2025, the content of each of which is incorporated by reference herein in their entireties and for all purposes.

### FIELD OF THE DISCLOSURE

The present disclosure relates to shim assemblies and, more particularly, to shim assemblies and related windows and doors.

### BACKGROUND

Shims may be used when installing windows and/or doors.

### SUMMARY

In a first implementation, an apparatus includes a window pane, a window frame carrying the window pane, and a shim assembly coupled to the window frame. The shim assembly includes a first plate, and a second plate movably coupled to the first plate, and a wedge assembly operable to change a distance between the first plate and the second plate.

In a second implementation, an apparatus includes a shim assembly including a first plate and a second plate movably coupled together, and a wedge assembly. Each of the first plate and the second plate includes a first end including a first inward tapered surface and a second end including a second inward tapered surface. A wedge assembly includes a first wedge engaging the first inward tapered surfaces of the first plate and the second plate, a second wedge engaging the second inward tapered surfaces of the first plate and the second plate, and a fastener passing through the first wedge, between the first plate and the second plate, and threadably engaging the second wedge. Rotating the fastener changes a distance between the first wedge and the second wedge and changes a distance between the first plate and the second plate.

In a third implementation, an apparatus includes a fenestration unit including a frame and a shim assembly. The frame includes a frame a head, a first jamb, a second jamb, and a sill, the first jamb and the second jamb coupled to and between the head and the sill. The shim assembly is coupled to the frame. The shim assembly includes a first plate, a second plate movably coupled to the first plate, and a wedge assembly operable to change a distance between the first plate and the second plate.

In further accordance with the foregoing first and/or second implementations, an apparatus and/or method may further comprise or include any one or more of the following:

In an implementation, each of the first plate and the second plate includes a first end including a first inward tapered surface and a second end including a second inward tapered surface.

In another implementation, the wedge assembly includes a first wedge engaging the first inward tapered surfaces of the first plate and the second plate, a second wedge engaging the second inward tapered surfaces of the first plate and the second plate, and a fastener passing through the first wedge, between the first plate and the second plate, and threadably engaging the second wedge. Rotating the fastener changes a distance between the first wedge and the second wedge and changes the distance between the first plate and the second plate.

In another implementation, the shim assembly includes a guide that guides relative movement between the first plate and the second plate.

In another implementation, the guide includes corresponding structures that interact to guide relative movement between the first plate and the second plate.

In another implementation, the guide includes ribs and grooves that receive one or more of the ribs.

In another implementation, the first plate includes first plate ribs and a first plate groove. The first plate groove is defined between a pair of the first plate ribs.

In another implementation, the second plate includes a second plate rib and a second plate groove defined by the second plate rib.

In another implementation, the ribs and the grooves are positioned on either side of first inward tapered surfaces of the first plate and the second plate and the second inward tapered surfaces of the first plate and the second plate.

In another implementation, one or more of the ribs include a bevel.

In another implementation, the first plate and the second plate include opposing surfaces that define a passage that is configured to receive a fastener.

In another implementation, the first plate and the second plate each include a central portion and side portions between which the central portion is positioned.

In another implementation, the side portions extend past the central portion on a first end of the first plate and the second plate and form a first end wedge guide and the side portions extend past the central portion on a second end of the first plate and the second plate and form a second end wedge guide.

In another implementation, the first wedge interacts with the first end wedge guide to guide relative movement of the first wedge and the second wedge interacts with the second end wedge guide to guide relative movement of the second wedge.

In another implementation, the shim assembly includes hinges that couple sides of the first plate and the second plate together.

In another implementation, the hinges include living hinges.

In another implementation, the first plate includes a guide rib aperture and the second plate includes a guide rib that is received by the guide rib aperture.

In another implementation, the second plate includes an outward facing fastener.

In another implementation, the outward facing fastener includes one or more spikes.

In another implementation, the outward facing fastener includes adhesive.

In an implementation, the first plate includes an inward facing fastener.

In an implementation, the inward facing fastener includes a U-shaped clip.

In another implementation, the U-shaped clip is configured to be coupled to a window frame or a door frame.

In another implementation, the apparatus includes a door panel and a door frame carrying the door panel. The shim assembly is coupled to the door frame.

In another implementation, the apparatus includes a window pane and a window frame carrying the window pane. The shim assembly is coupled to the window frame.

In another implementation, the second plate includes an outward facing fastener.

In another implementation, the outward facing fastener includes one or more spikes.

In another implementation, the shim assembly includes a guide that guides relative movement between the first plate and second plate.

In another implementation, the guide includes corresponding structures that interact to guide relative movement between the first plate and the second plate.

In another implementation, the structures include ribs of the second plate and slots of the second plate, the ribs of the second plate are to be received by the slots of the first plate.

In another implementation, the ribs include a pair of U-shaped ribs and the slots include a pair of U-shaped slots, the U-shaped ribs of the second plate that are receivable in U-shaped slots of the first plate.

In another implementation, an interaction between the U-shaped ribs of the second plate and surfaces defining the U-shaped slots of the first plate guide relative movement between the first plate and the second plate.

In another implementation, the U-shaped ribs oppose one another.

In another implementation, the structures include ribs of the first plate and cut-outs of the second plate, the ribs of the first plate are receivable in the cut-outs of the second plate.

In another implementation, an interaction between the ribs of the first plate and surfaces defining the cut-outs of the second plate guide relative movement between the first plate and the second plate.

In another implementation, the apparatus includes an elastic band surrounding the shim assembly to movably couple the first plate and the second plate together.

In another implementation, the elastic band is to urge the first plate toward the second plate.

In another implementation, the first plate and the second plate include an exterior groove to receive the elastic band.

In another implementation, the fenestration unit comprises a door.

In another implementation, the fenestration unit comprises a window.

### BRIEF DESCRIPTION OF THE DRAWINGS

FIG. 1 is a front view of an example window in accordance with the teachings of this disclosure.

FIG. 2 is an expanded isometric view of one of the shim assemblies that can be used to implement the window of FIG. 1 or any of the disclosed implementations.

FIG. 3 is an isometric view of the shim assembly of FIG. 2 that can be used to implement the window of FIG. 1.

FIG. 4 is an end view of the shim assembly of FIG. 2 that can be used to implement the window of FIG. 1.

FIG. 5 is an end view of an alternative implementation of a shim assembly that can be used to implement the window of FIG. 1 or any of the disclosed implementations.

FIG. 6 is an isometric view of an example implementation of a shim assembly that can be used to implement the shim assembly of FIG. 5, the window of FIG. 1, and/or any of the disclosed implementations.

FIG. 7 is a side view of the shim assembly of FIG. 6.

FIG. 8 is an end view of an example implementation of a shim assembly that can be used to implement the shim assembly of FIG. 5, the window of FIG. 1, and/or any of the disclosed implementations.

FIG. 9 is an isometric view of an example implementation of a shim assembly that can be used to implement the shim assembly of FIG. 5, the window of FIG. 1, and/or any of the disclosed implementations.

FIG. 10 is a front view an example implementation of a shim assembly that is shown coupled to the window frame of FIG. 1.

FIG. 11 is a front view of an example door in accordance with the teachings of this disclosure.

FIG. 12 shows an expanded isometric view of an example implementation of a shim assembly that can be used to implement the shim assembly of FIG. 2, the window of FIG. 1, and/or any of the disclosed implementations.

FIG. 13 shows another expanded isometric view of the shim assembly of FIG. 12 including the first plate, the second plate, and the wedge assembly.

FIG. 14 shows an isometric view of the shim assembly of FIG. 12.

### DETAILED DESCRIPTION

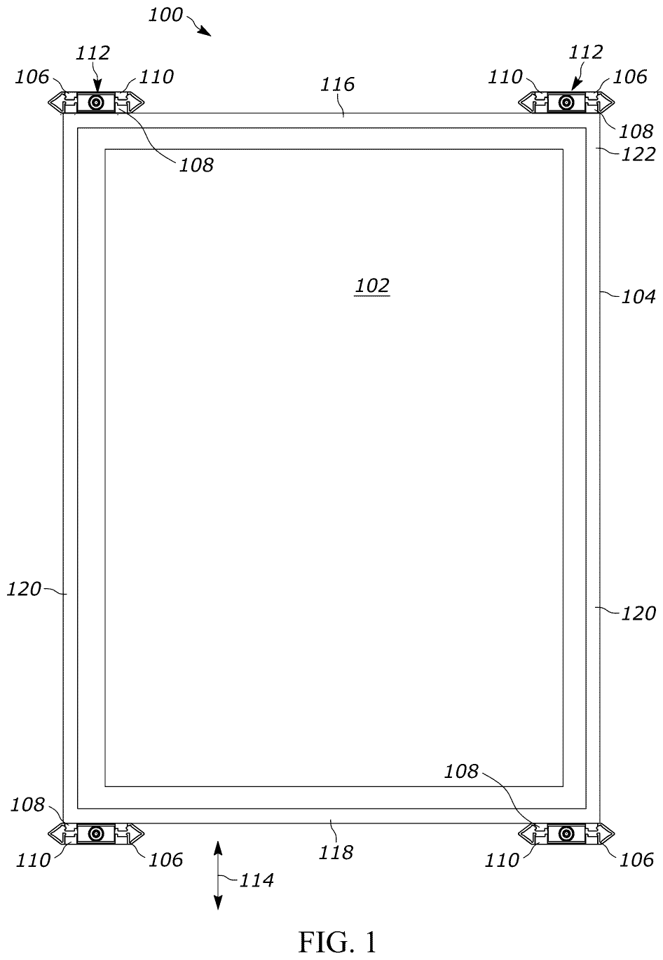

FIG. 1 is a front view of an example window 100 in accordance with the teachings of this disclosure. The window 100 may be referred to as a fenestration unit. The window 100 may be an aluminum window, a single hung window, a double-hung window, a casement window, an awning window, a slider window, a picture window, a bay window, a bow window, a skylight window, a hopper window, and/or a utility slider window as examples.

The window 100 includes a window pane 102, a window frame 104 carrying the window pane 102, and a plurality of shim assemblies 106 coupled to the window frame 104. The shim assemblies 106 may be used with any fenestration unit. For example, the shim assemblies 106 may be used with fenestration units implemented as doors and/or windows as examples. The shim assemblies 106 may be referred to as anchors. Each shim assembly 106 includes a first plate 108, a second plate 110 movably coupled to the first plate 105, and a wedge assembly 112 operable to change a distance between the first plate 108 and the second plate 110 in a direction generally indicated by arrows 114. While the shim assemblies 106 are shown coupled to a header 116 and a sill 118 of the window frame 104, the shim assemblies 106 may additionally or alternatively be coupled to jambs 120. The jambs 120 may be referred to as a first jamb 120 and a second jamb 120. The shim assemblies 106 are shown positioned at corners 122 of the window frame 104 to enable the forces imparted by the shim assemblies 116 to be received by the jambs 120 and/or to deter the header 116 and/or the sill 118 from bowing.

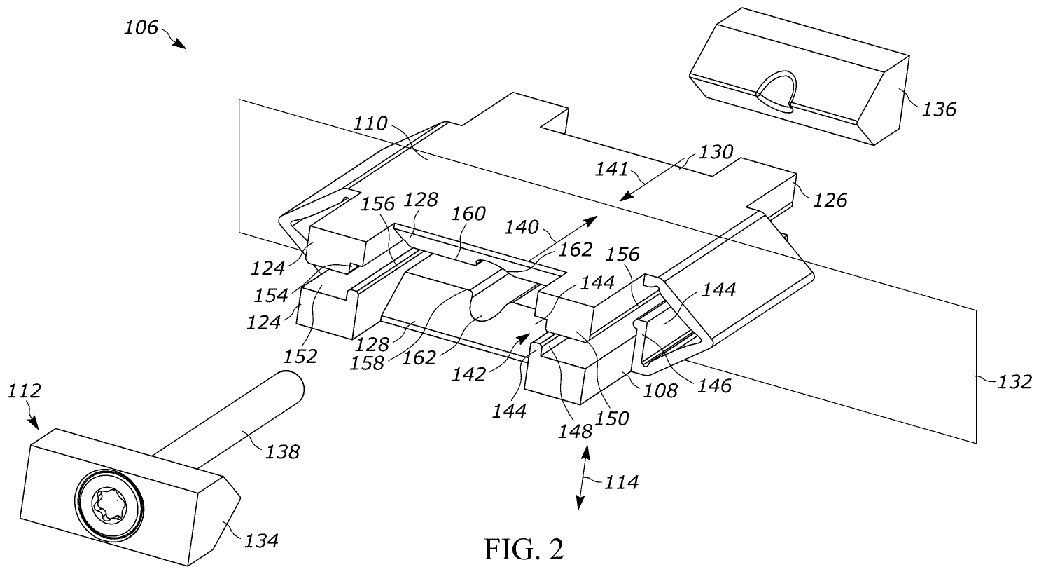

FIG. 2 is an expanded isometric view of one of the shim assemblies 106 that can be used to implement the window of FIG. 1 or any of the disclosed implementations. Each of the first plate 108 and the second plate 110 in the implementation shown includes a first end 124 and a second end 126. The first end 124 of the first plate 108 and the second plate 110 includes first inward tapered surfaces 128 and the second end 126 of the first plate 108 and the second plate 110 includes second inward tapered surface 130. The first inward tapered surface 128 is opposite the second inward tapered surface 130 and the first plate 108 and the second plate 110 are shown being substantially symmetric across a central plane 132.

The wedge assembly 112 includes a first wedge 134, a second wedge 136, and a fastener 138. When the shim assembly 106 is assembled, the first wedge 134 engages the first inward tapered surface 128 of the first plate 108 and the second plate 110, the second wedge 136 engages the second inward tapered surface 130 of the first plate 108 and the second plate 110, and the fastener 138 passes through the first wedge 134, between the first plate 108 and the second plate 110, and threadably engaging the second wedge 136. The fastener 138 is configured to rotate and change a distance between the first wedge 134 and the second wedge 136 in a direction generally indicated by arrows 140,141 and change a distance between the first plate 108 and the second plate 110 in a direction generally indicated by arrow 114. The fastener 138 may be rotated in a first direction to enable the first plate 108 and the second plate 110 to move away from one another. The fastener 138 may be rotated in a second direction opposite the first direction to enable the first plate 108 and the second plate 110 to move toward one another. A technician using the shim assemblies 106 may, thus, dynamically adjust a distance between the first plate 108 and the second plate 110 as desired.

The shim assembly 106 has a guide 142 that guides relative movement between the first plate 108 and the second plate 110 in the implementation shown. The guide 142 may inhibit movement of the first plate 108 and the second plate 110 in opposite side-to-side directions to deter the first plate 108 from moving to the left as the second plate 110 moves to the right, for example.

The guide 142 includes corresponding structures 144 that interact to guide relative movement between the first plate 108 and the second plate 110. The guide 142 has ribs 146, 148, 150 and grooves 152, 154 that receive one or more of the ribs 146, 148, 150 in the implementation shown. The first plate 108 is shown including the first plate ribs 146, 148 and the first plate groove 152. The first plate groove 152 is defined between a pair of the first plate ribs 146, 148.

The second plate 110 has the second plate rib 150 and the second plate groove 154 defined by the second plate rib 150. The ribs 146, 148, 150 and the grooves 152, 154 are positioned on either side of the first inward tapered surface 128 and the second inward tapered surface 130 of the first plate 108 and the second plate 110. One or more of the ribs 146, 148, 150 has a bevel 156 as shown.

The first plate 108 and the second plate 110 have opposing surfaces 158, 160 that define a passage 162 that receives the fastener 138. The fastener 138 is rotatable within the passage 162 to draw the first wedge 134 and the second wedge 136 toward one another and cause the first plate 108 and the second plate 110 to move away from one another as an example. The fastener 138 is also rotatable to move the first wedge 134 and the second wedge 136 away from one another to enable the first plate 108 and the second plate 110 to move toward one another.

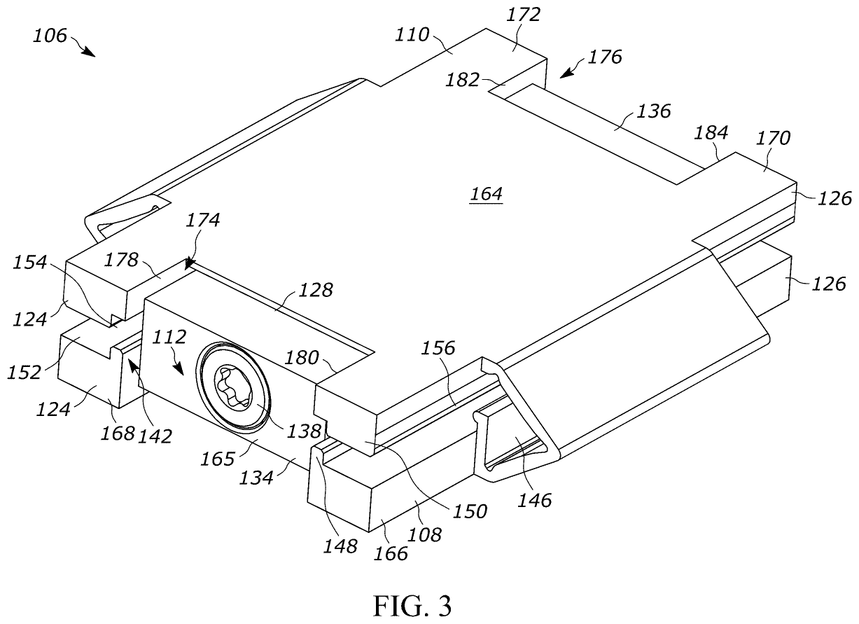

FIG. 3 is an isometric view of the shim assembly 106 of FIG. 2 that can be used to implement the window 100 of FIG. 1. The first plate 108 and the second plate 110 have a central portion 164, 165 and side portion 166, 168, 170, 172 between which the corresponding central portions 164, 165 are positioned.

The side portions 166, 168, 170, 172 extend past the central portion 164, 165 on the first end 124 of the first plate 108 and the second plate 110 and form a first end wedge guide 174. The side portions 166, 168, 170, 172 extend past the central portion 164, 165 on the second end 126 of the first plate 108 and the second plate 110 and form a second end wedge guide 176.

The first wedge 134 interacts with the first end wedge guide 174 to guide relative movement of the first wedge 134 and the second wedge 136 interacts with the second end wedge guide 176 to guide relative movement of the second wedge 136. The first end wedge guide 174 is defined by opposing surfaces 178, 180 and the second end wedge guide 176 is defined by opposing surfaces 182, 184.

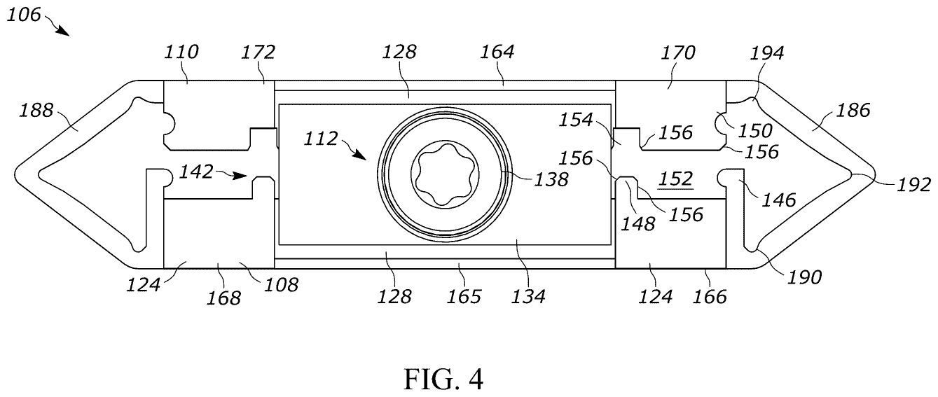

FIG. 4 is an end view the shim assembly 106 of FIG. 2 that can be used to implement the window 100 of FIG. 1. The shim assembly 106 includes hinges 186, 188 that couple sides of the first plate 108 and the second plate 110 together. The hinges 186, 188 are living hinges 190, 192, 194 in the implementation shown. Each hinge 186 may include three living hinges 190, 192, 194 as shown. The hinges 186, 188 may be implemented differently and/or the first plate 108 and the second plate 110 may be movably coupled in different ways, however. The hinges 186 and/or 188 may be configured to bias the first plate 108 toward the second plate 110 in some examples.

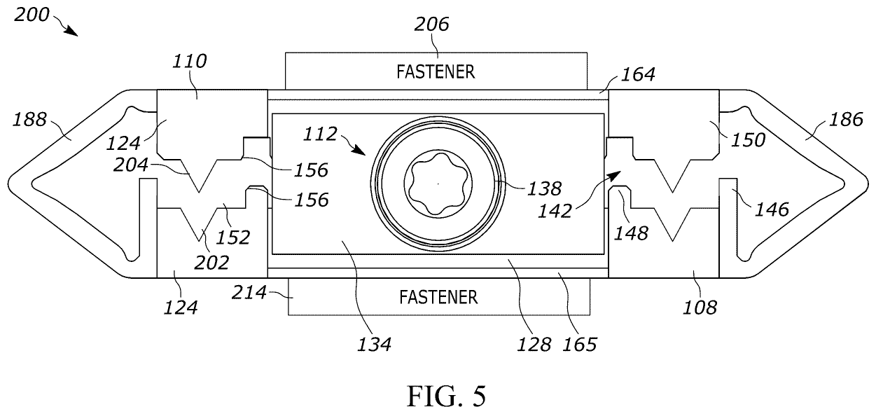

FIG. 5 is an end view of an alternative implementation of a shim assembly 200 that can be used to implement the window 100 of FIG. 1 or any of the disclosed implementations. The shim assembly 200 of FIG. 5 is substantially similar to the shim assembly 106 of FIG. 2 but the first plate 108 has a guide rib aperture 202 and the second plate 110 has a guide rib 204 that is received by the guide rib aperture 202. The rib aperture 202 and the guide rib 204 have corresponding tapered surfaces that facilitate alignment between the first plate 108 and the second plate 110. The guide rib aperture 202 may be implemented by a channel that extends between the first end 124 and the second end 126 and the guide rib 204 may also extend between the first end 124 and the second end 126.

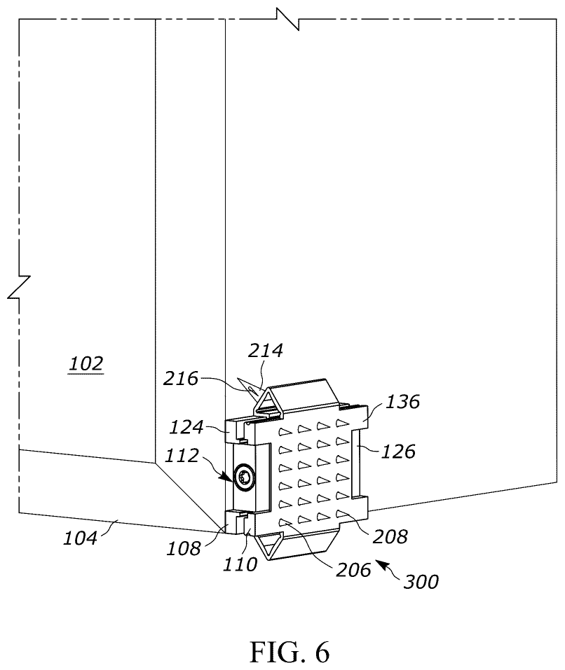

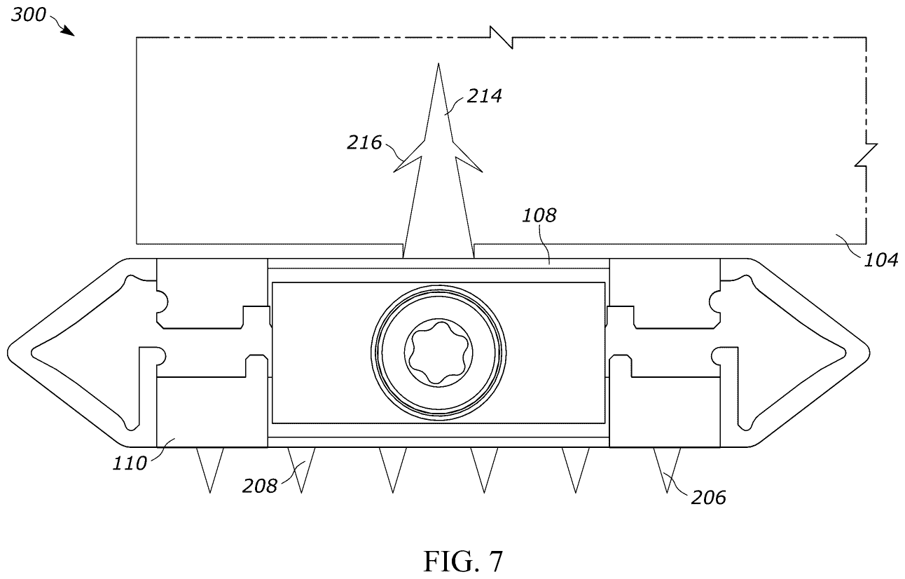

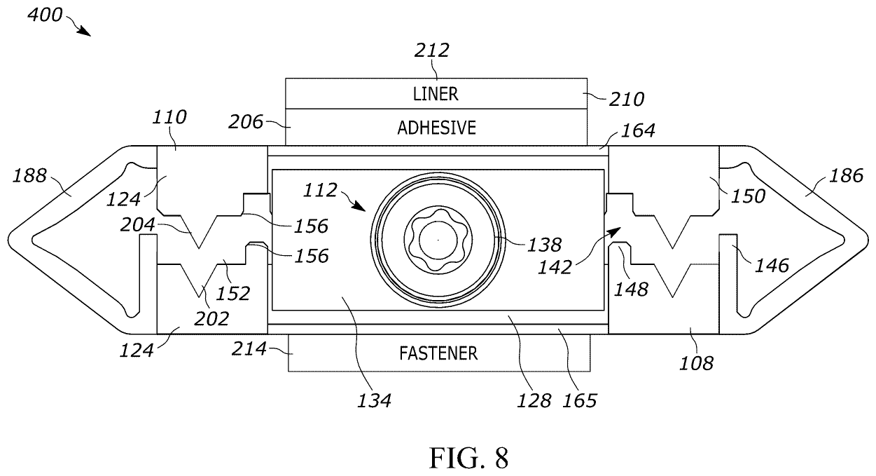

The shim assembly 200 includes an outward facing fastener 206. The outward facing fastener 206 is shown extending from the second plate 110. The outward facing fastener 206 may alternatively extend from the first plate 108. The outward facing fastener 206 may be configured to facilitate a coupling between the shim assembly 200 and surfaces defining an opening of a structure in which the window 100 and/or a door carrying the shim assembly 108 is positioned. The opening may be a rough window opening or a rough door opening as examples. The outward facing fastener 206 may be implemented by one or more spikes 208 (see, FIGS. 6 and 7) and/or adhesive 210 (see, FIG. 8). A liner 212 (see, FIG. 8) may cover the adhesive 210 prior to use. The outward facing fastener 206 may be implemented in different ways or alternatively may be omitted.

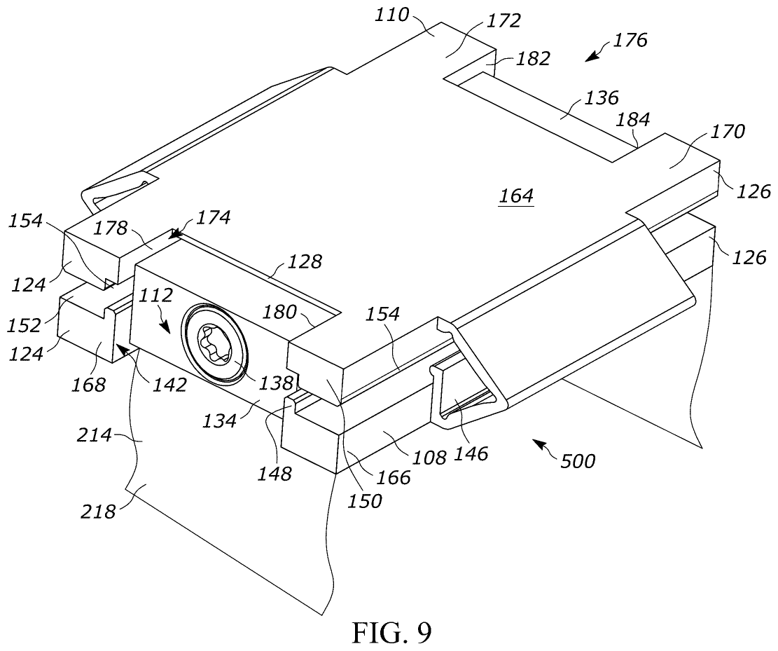

The shim assembly 200 includes an inward facing fastener 214. The inward facing fastener 214 is shown extending from the first plate 108. The inward facing fastener 214 may alternatively extend from the second plate 110. The inward facing fastener 214 may be configured to facilitate a coupling between the shim assembly 200 and the window frame 104 of the window 100 of FIG. 1 and/or a coupling between the shim assembly 200 and any other structure such as a door frame. The inward facing fastener 214 may be implemented by a spike 216 (see, FIGS. 6 and 7) and/or a U-shaped clip 218 (FIG. 9). The spike 216 may be implemented by one or more screws and/or nails. The inward facing fastener 214 may be implemented in different ways or alternatively may be omitted.

FIG. 6 is an isometric view of an example implementation of a shim assembly 300 coupled to window frame 104 that can be used to implement the shim assembly 200 of FIG. 5, the window 100 of FIG. 1, and/or any of the disclosed implementations. The shim assembly 300 includes the outward facing fastener 206 implemented by a plurality of spikes 208 and the inward facing fastener 214 implemented by a spike 216.

FIG. 7 is a side view of the shim assembly 300 of FIG. 6.

FIG. 8 is an end view of an example implementation of a shim assembly 400 that can be used to implement the shim assembly 200 of FIG. 5, the window 100 of FIG. 1, and/or any of the disclosed implementations. The shim assembly 400 includes the outward facing fastener 206 implemented by the adhesive 210. The adhesive 210 is shown covered by the liner 212. The liner 212 is removable to allow the adhesive 210 to be adhered to a surface, for example.

FIG. 9 is an isometric view of an example implementation of a shim assembly 500 that can be used to implement the shim assembly 200 of FIG. 5, the window 100 of FIG. 1, and/or any of the disclosed implementations. The shim assembly 500 includes the inward facing fastener 214 implemented by the U-shaped clip 218. The U-shaped clip 218 may be configured to be attached to the window frame 104 of the window 100 of FIG. 1. The U-shaped clip 218 may additionally or alternatively be configured to be attached to another frame such as a door frame.

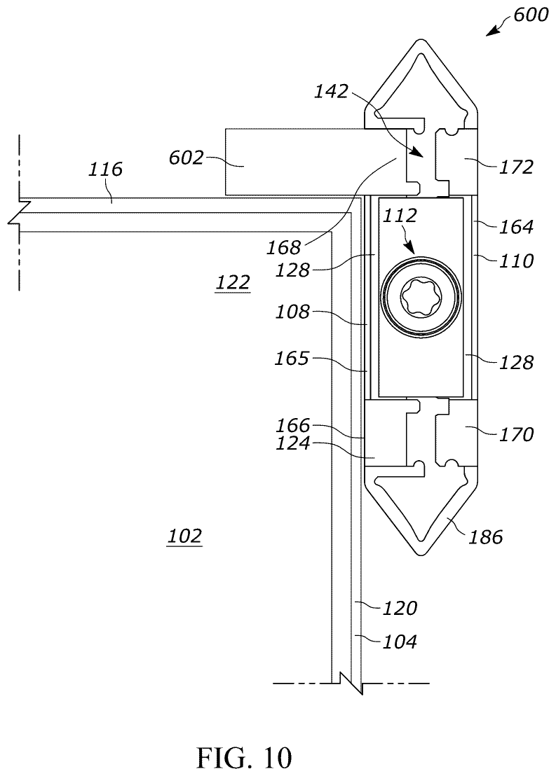

FIG. 10 is a front view an example implementation of a shim assembly 600 that is shown coupled to the window frame 104 of FIG. 1. The shim assembly 600 is shown coupled to the jamb 120 of the window frame 104 but may additionally or alternatively be coupled to the header 116 and/or the sill 118. The shim assembly 600 may also be used with a door frame as an example.

The shim assembly 600 of FIG. 10 is substantially similar as the shim assembly 106 of FIG. 2. The shim assembly 600 of FIG. 10 includes a bracket 602. The bracket 602 is configured to go about a corner 122 of the window frame 104, for example, to further secure the relative position of the shim assembly 600, the window frame 104, and/or the opening of the structure sized to receive the window 100 and/or door.

The bracket 602 may be positioned to extend from the side portion 168 as shown or, alternatively, the bracket 602 may extend from any one of the other side portions 166, 170, 172 of the shim assembly 600. Other arrangements of the bracket 602 may prove suitable.

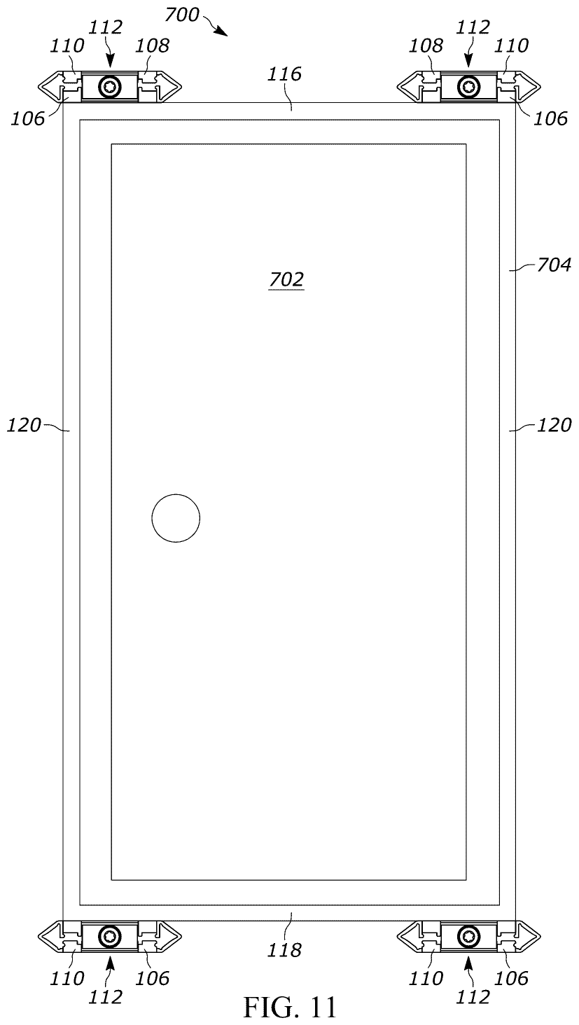

FIG. 11 is a front view of an example door 700 in accordance with the teachings of this disclosure. The door 700 may be referred to as a fenestration unit. The door 700 includes a door panel 702, a door frame 704 carrying the panel 702, and a plurality of the shim assemblies 106 coupled to the door frame 704. The door panel 702 may alternatively be referred to as a door leaf.

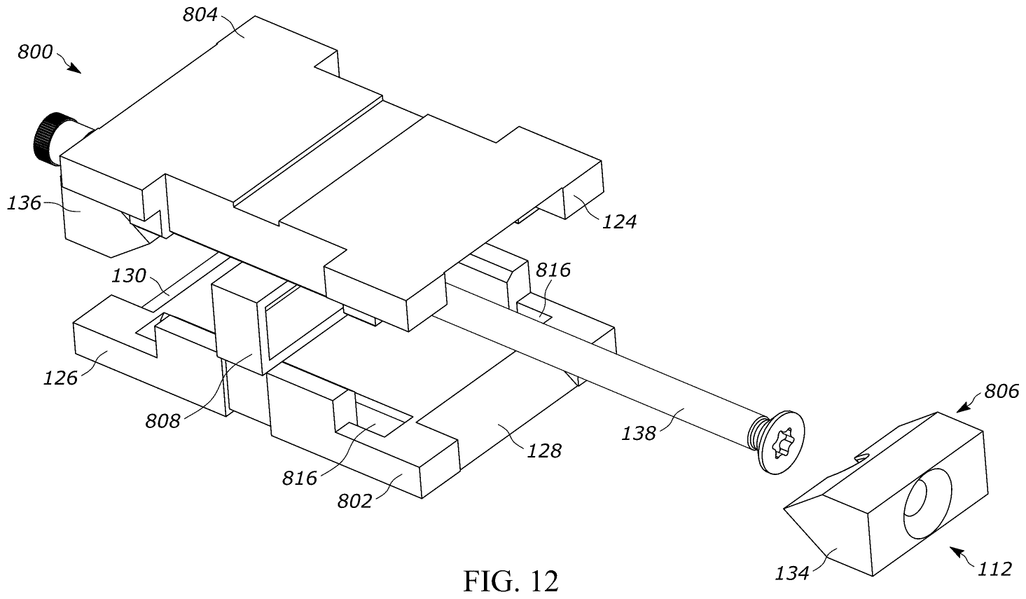

FIG. 12 shows an expanded isometric view of an example implementation of a shim assembly 800 that can be used to implement the shim assembly 200 of FIG. 2, the window 100 of FIG. 1, and/or any of the disclosed implementations. The shim assembly 800 of FIG. 12 includes a first plate 802, a second plate 804, and a wedge assembly 806. The first plate 802 and the second plate 804 are movably coupled together. An elastic band 808 is to surround the shim assembly 800 in the implementation shown. The elastic band 808 movably couples the first plate 802 and the second plate 804 together.

Each of the first plate 802 and the second plate 804 includes the first end 124 includes the first inward tapered surface 128 and the second end 126 including the second inward tapered surface 130. The wedge assembly 806 includes the first wedge 124, the second wedge 136, and the fastener 138. The first wedge 134 engaging the first inward tapered surfaces 128 of the first plate 802 and the second plate 804 and the second wedge 136 engaging the second inward tapered surfaces 130 of the first plate 802 and the second plate 804. The fastener 138 passing through the first wedge 134, between the first plate 802 and the second plate 804, and threadably engaging the second wedge 136. In operation, the fastener 138 may be rotated to change a distance between the first wedge 134 and the second wedge 136 and changes a distance between the first plate 802 and the second plate 804.

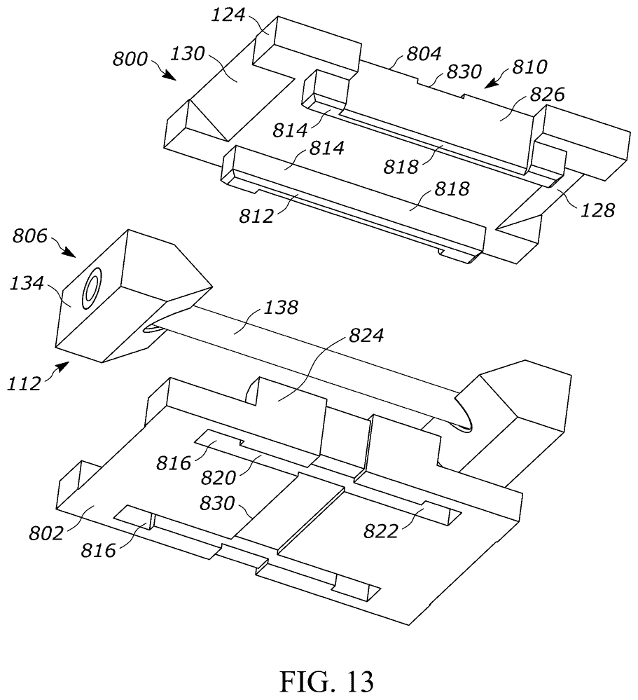

FIG. 13 shows another expanded isometric view of the shim assembly 800 of FIG. 12 including the first plate 802, the second plate 804, and the wedge assembly 806. The shim assembly 800 includes a guide 810 that guides relative movement between the first plate 802 and second plate 804. The guide 810 includes corresponding structures 812 that interact to guide relative movement between the first plate 802 and the second plate 804.

The structures 812 include ribs 814 of the second plate 804 and slots 816 of the first plate 802. The ribs 814 are to be received by slots 816 of the first plate 802. The ribs 814 are a pair of U-shaped ribs 818 of the second plate 804 that are receivable in U-shaped slots 820 of the first plate 802. An interaction between the U-shaped ribs 818 of the second plate 804 and surfaces 822 defining the U-shaped slots 820 of the first plate 802 guide relative movement between the first plate 802 and the second plate 804. The U-shaped ribs 818 oppose one another in the example shown. The U-shaped ribs 818 may face one another in other examples and/or have a different shape. For example, the ribs 814 may be rectangular and/or have a curvature.

The structures 812 is also shown including ribs 824 of the first plate 802 and cut-outs 826 of the second plate 804. The ribs 824 are receivable in the corresponding cut-outs 826 of the second plate 804 in the implementation shown. The cut-outs 826 open outwardly on lateral sides of the second plate 804. The cut-outs 826 oppose one another. An interaction between the ribs 824 of the first plate 802 and surfaces defining the cut-outs 826 of the second plate 804 guide relative movement between the first plate 802 and the second plate 804.

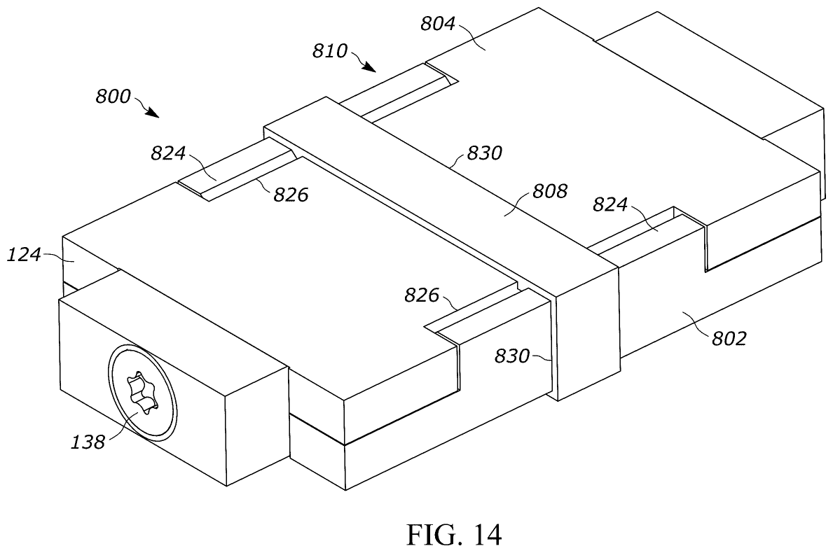

FIG. 14 shows an isometric view of the shim assembly 800 of FIG. 12. The elastic band 808 is shown surrounding the shim assembly 800 to movably couple the first plate 802 and the second plate 804 together. The elastic band 808 urges the first plate 802 toward the second plate 804. The first plate 802 and the second plate 804 include an exterior groove 830 (shown more clearing in FIG. 13) that receive the elastic band 808.

The disclosed implementations relate to shim assemblies for use with fenestration units such as windows and/or doors. In at least some aspects, the example expandable shim comprises a first body (e.g., an upper body) having an at least a substantially planar first surface (e.g., an “outer” or “upper” surface) opposite a second surface (e.g., an “inner” or “lower” surface) and a second body (e.g., a lower body) having an at least substantially planar first surface (e.g., an “outer” or “lower” surface) opposite a second surface (e.g., an “upper” or “inner” surface), wherein the second surface of the first body and the second surface of the second body are configured, in at least some examples, with at least substantially mating profiles to facilitate compactness of the expandable shim in a closed position.

At a first end (e.g., a front end) of the example expandable shim is a first movable member and at a second end (e.g., a rear end) of the example expandable shim is a second movable member.

In at least some examples disclosed, the first movable member comprises, at an inner portion, a first wedge having a first face (e.g., an upper face) configured to matingly engage a correspondingly angled surface formed in an interior of the first end of the first body and having a second face (e.g., a lower face) configured to matingly engage a correspondingly angled surface formed in an interior of the first end of the second body. Likewise, the second movable member comprises, at an inner portion, a second wedge having a first face (e.g., an upper face) configured to matingly engage a correspondingly angled surface formed in an interior of the second end of the first body and having a second face (e.g., a lower face) configured to matingly engage a correspondingly angled surface formed in an interior of the second end of the second body.

A drive member is disposed to extend from a first end (e.g., a proximal end) at the first movable member, across and between the second surface of the first body and the second surface of the second body, to a second end (e.g., a distal end) at the second movable member. In some examples, the drive member comprises a first threaded portion at a first end portion and comprises a second threaded portion at a second end portion, wherein the first threaded portion engages the first movable member and the second threaded portion engages the second movable member.

In operation, as the example drive member is rotated, such as via a head configured with a recess to accept a drive head and a corresponding drive element, such as a screwdriver or bit (e.g., a Phillips head, a flat head, a Torx head, etc.), the drive member and, correspondingly the first movable member and the second movable member, are collectively configured so that rotation of the drive member drives the first movable member and the second movable member inwardly, thereby causing the first wedge of the first movable member to bias the first face and the second face against the mating angled surfaces formed in the first end of the first body and the second body and the second wedge of the second movable member to bias the first face and the second face against the mating angled surfaces formed in the second end of the first body and the second body. As the first wedge and the second wedge drive inwardly with continued rotation of the drive member, the first wedge and the second wedge drive apart the first body and the second body, forcing them apart in a direction perpendicularly to the axis of rotation of the drive member. In this way, the at least substantially planar first surface of the first body and the at least substantially planar first surface of the second body move apart with increasing rotation of the drive member and increasing inward displacement of each of the first movable member and the second movable member. Additionally, as the shim expands, the first threaded portion and second threaded portion of the drive member will lock the expandable shim in place at the desired level of expansion and provide stable support.

In some examples, the drive member may extend beyond an extent of the first movable member, the second movable member, or both the first movable member and the second movable member, to allow manual manipulation by a user's fingers via a knurled knob, or the like, at one or both ends of the expandable shim.

In some of the illustrated examples, an example resilient member is shown to circumscribe a central portion of the first body and the second body to bias the first body and the second body into a closed state. In another example, one or more biasing members may be disposed externally to the first body and the second body (e.g., a biasing member could substantially encapsulate the first body and the second body). In another example, one or more biasing members may be disposed internally to the first body and the second body, such as by resilient members connected to each of the first body and the second body (e.g., springs symmetrically embedded within recesses of each of the first body and the second body at edge or corner portions thereof). In another example, a viscous substance (e.g., a wax, etc.) or a light adhesive could be applied at at least part of the second surfaces of the first body and the second body to provide a small degree of adhesion that would tend to maintain the expandable shim in a closed state prior to deployment. In yet another example, a latch, lock, pin or releasable male/female connector could be integrated the first body and the second body to maintain the expandable shim in a closed state prior to deployment.

In various aspects, the first body, second body, the first movable member, and the second movable member may be formed from, without limitation, stainless steel, zinc-plated steel, an alloy, high-density polyethylene (HDPE), polyoxymethylene (POM), a thermoplastic, or a polystyrene plastic.

In various aspects, an expandable shim kit may include an expandable shim, such as disclosed herein by way of example, and a plurality of differently configured first bodies and/or second bodies wherein each of the one or more first bodies and each of the one or more second bodies differ in one or more characteristics from the corresponding one or more characteristics of the first body and the second body of the expandable shim. For example, a height of the plurality of differently configured first bodies and/or second bodies could each increase by a predetermined amount (e.g., +1.0 mm, +2.0 mm, +3.0 mm, +4.0 mm, etc., or by some other increment (e.g., +0.25″, +0.50′, +0.75″, etc.)) to permit adaptability of the base expandable shim as needs dictate. In some examples, the plurality of differently configured first bodies and/or second bodies may comprise one or more first bodies and/or one or more second bodies having a first surface that is transversely curvilinear to facilitate mating engagement to a non-planar surface adjacent a corresponding one of the first surface of the first body or first surface of the second body.

Likewise, the expandable shim kit could include a plurality of differently configured first movable members and/or second movable members wherein each of the one or more first movable members and each of the one or more second movable members differ in one or more characteristics from the corresponding one or more characteristics of the first movable member and the second movable member of the expandable shim. For example, a first wedge configuration and a second wedge configuration of the plurality of differently configured first movable members and second movable members could be different than that of the first movable member and the second movable member of the expandable shim.

The disclosed expandable shim thus permits easy adjustment to enable precision shimming with, unlike traditional shims, a uniform expansion to provide full contact and a secure hold with a flat shape that permits insertion into tight spaces.

### Examples of Combinations

Example 1. An apparatus, comprising: a window pane; a window frame carrying the window pane; and a shim assembly coupled to the window frame, the shim assembly, comprising: a first plate; and a second plate movably coupled to the first plate; and a wedge assembly operable to change a distance between the first plate and the second plate.

Example 2. The apparatus of Example 1, wherein each of the first plate and the second plate, comprises: a first end comprising a first inward tapered surface; and a second end comprising a second inward tapered surface.

Example 3. The apparatus of Example 2, wherein the wedge assembly, comprises: a first wedge engaging the first inward tapered surfaces of the first plate and the second plate; a second wedge engaging the second inward tapered surfaces of the first plate and the second plate; and a fastener passing through the first wedge, between the first plate and the second plate, and threadably engaging the second wedge, wherein rotating the fastener changes a distance between the first wedge and the second wedge and changes the distance between the first plate and the second plate.

Example 4. The apparatus of any one of the preceding Examples, wherein the shim assembly comprises a guide that guides relative movement between the first plate and the second plate.

Example 5. The apparatus of Example 4, wherein the guide comprises corresponding structures that interact to guide relative movement between the first plate and the second plate.

Example 6. The apparatus of any one of Examples 4- 5, wherein the guide comprises ribs and grooves that receive one or more of the ribs.

Example 7. The apparatus of Example 6, wherein the first plate comprises first plate ribs and a first plate groove, wherein the first plate groove is defined between a pair of the first plate ribs.

Example 8. The apparatus of any one of Examples 6- 7, wherein the second plate comprises a second plate rib and a second plate groove defined by the second plate rib.

Example 9. The apparatus of any one of Examples 6- 8, wherein the ribs and the grooves are positioned on either side of the first inward tapered surfaces of the first plate and the second plate and the second inward tapered surfaces of the first plate and the second plate.

Example 10. The apparatus of any one of Examples 6- 9, wherein one or more of the ribs comprise a bevel.

Example 11. The apparatus of any one of the preceding Examples, wherein the first plate and the second plate comprise opposing surfaces that define a passage that is configured to receive a fastener.

Example 12. The apparatus of any one of the preceding Examples, wherein the first plate and the second plate each comprise a central portion and side portions between which the central portion is positioned.

Example 13. The apparatus of Example 12, wherein the side portions extend past the central portion on a first end of the first plate and the second plate and form a first end wedge guide and wherein the side portions extend past the central portion on a second end of the first plate and the second plate and form a second end wedge guide.

Example 14. The apparatus of Example 13, wherein the first wedge interacts with the first end wedge guide to guide relative movement of the first wedge and the second wedge interacts with the second end wedge guide to guide relative movement of the second wedge.

Example 15. The apparatus of any one of the preceding Examples, wherein the shim assembly comprises hinges that couple sides of the first plate and the second plate together.

Example 16. The apparatus of Example 15, wherein the hinges comprise living hinges.

Example 17. The apparatus of any one of the preceding Examples, wherein the first plate comprises a guide rib aperture and the second plate comprises a guide rib that is received by the guide rib aperture.

Example 18. The apparatus of any one of the preceding Examples, wherein the second plate comprises an outward facing fastener.

Example 19. The apparatus of Example 18, wherein the outward facing fastener comprises one or more spikes.

Example 20. The apparatus of Example 19, wherein the outward facing fastener comprises adhesive.

Example 21. An apparatus, comprising: a shim assembly, comprising: a first plate and a second plate movably coupled together, each of the first plate and the second plate, comprising: a first end comprising a first inward tapered surface; and a second end comprising a second inward tapered surface; and a wedge assembly, comprising: a first wedge engaging the first inward tapered surfaces of the first plate and the second plate; a second wedge engaging the second inward tapered surfaces of the first plate and the second plate; and a fastener passing through the first wedge, between the first plate and the second plate, and threadably engaging the second wedge, wherein rotating the fastener changes a distance between the first wedge and the second wedge and changes a distance between the first plate and the second plate.

Example 22. The apparatus of Example 21, wherein the first plate comprises an inward facing fastener.

Example 23. The apparatus of Example 22, wherein the inward facing fastener comprises a U-shaped clip.

Example 24. The apparatus of Example 23, wherein the U-shaped clip is configured to be coupled to a window frame or a door frame.

Example 25. The apparatus of any one of the Examples 21- 24, further comprising a door panel and a door frame carrying the door panel, wherein the shim assembly is coupled to the door frame.

Example 26. The apparatus of any one of the Examples 21- 24, further comprising a window pane and a window frame carrying the window pane, wherein the shim assembly is coupled to the window frame.

Example 27. The apparatus of any one of Examples 21- 26, wherein the second plate comprises an outward facing fastener.

Example 28. The apparatus of Example 27, wherein the outward facing fastener comprises one or more spikes.

Example 29. The apparatus of any one of claims 21-28, wherein the shim assembly comprises a guide that guides relative movement between the first plate and second plate.

Example 30. The apparatus of claim 29, wherein the guide comprises corresponding structures that interact to guide relative movement between the first plate and the second plate.

Example 31. The apparatus of claim 30, wherein the structures comprise ribs of the second plate and slots of the second plate, the ribs of the second plate are to be received by the slots of the first plate.

Example 32. The apparatus of claim 31, wherein the ribs comprise a pair of U-shaped ribs and the slots comprise a pair of U-shaped slots, the U-shaped ribs of the second plate that are receivable in U-shaped slots of the first plate.

Example 33. The apparatus of claim 31, wherein an interaction between the U-shaped ribs of the second plate and surfaces defining the U-shaped slots of the first plate guide relative movement between the first plate and the second plate.

Example 34. The apparatus of claim 33, wherein the U-shaped ribs oppose one another.

Example 35. The apparatus of any one of claims 30-34, the structures include ribs of the first plate and cut-outs of the second plate, the ribs of the first plate are receivable in the cut-outs of the second plate.

Example 36. The apparatus of claim 35, wherein an interaction between the ribs of the first plate and surfaces defining the cut-outs of the second plate guide relative movement between the first plate and the second plate.

Example 37. The apparatus of any one of claims 21-36, further comprising an elastic band surrounding the shim assembly to movably couple the first plate and the second plate together.

Example 38. The apparatus of claim 37, wherein the elastic band is to urge the first plate toward the second plate.

Example 39. The apparatus of any one of claims 37-38, wherein the first plate and the second plate comprise an exterior groove to receive the elastic band.

Example 40. An apparatus, comprising: a fenestration unit, comprising: a frame, comprising a head, a first jamb, a second jamb, and a sill, the first jamb and the second jamb coupled to and between the head and the sill, a shim assembly coupled to the frame, the shim assembly, comprising: a first plate; and a second plate movably coupled to the first plate; and a wedge assembly operable to change a distance between the first plate and the second plate.

Example 41. The apparatus of Example 40, wherein the fenestration unit comprises a door.

Example 42. The apparatus of Example 40, wherein the fenestration unit comprises a window.

Example 43. An expandable shim, comprising: a first body having an at least substantially planar first surface and a second surface opposite the first surface; a second body having an at least substantially planar first surface and a second surface opposite the first surface; a first movable member disposed at a first end of the first body and the second body, the first movable member comprising a first wedge having at least one surface configured to engage a correspondingly surface formed in an interior of the first end of the first body or the second body; a second movable member disposed at a second end of the first body and the second body, the second movable member comprising a second wedge having at least one surface configured to engage a correspondingly surface formed in an interior of the second end of the first body or the second body; a drive member extending from a first end at the first movable member, across and between the second surface of the first body and the second surface of the second body, to a second end at the second movable member, the drive member comprising a first threaded portion at a first end portion and a second threaded portion at a second end portion with the first threaded portion engaging a mating threaded portion of the first movable member and the second threaded portion engaging a mating threaded portion of the second movable member, wherein the second surface of the first body and the second surface of the second body are configured with at least substantially mating profiles, wherein rotation of the drive member in a first direction biases the first movable member and the second movable member inwardly, to force apart the first body and the second body in an amount related to an inward translation of the first movable member and the second movable member, and wherein rotation of the drive member in a second direction biases the first movable member and the second movable member outwardly, to bring together the first body and the second body in an amount related to an outward translation of the first movable member and the second movable member.

Example 44. The expandable shim according to Example 43, further comprising: at least one resilient member disposed between the second surfaces of the first body and the second body to bias the first body and the second body toward one another.

Example 44. The expandable shim according to Example 43, further comprising: at least one resilient member disposed to circumscribe the first body and the second body to bias the first body and the second body toward one another.

Example 44. The expandable shim according to Example 43, further comprising: at least one resilient member disposed on an exterior of the first body and the second body to bias the first body and the second body toward one another.

Example 44. The expandable shim according to Example 43, further comprising: a locking member disposed on an exterior of the first body and the second body to releasably lock the first body and the second body to one another.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The following claims recite aspects of certain examples of the disclosed subject matter and are considered to be part of the above disclosure. These aspects may be combined with one another.

1. An apparatus, comprising:
a window pane;
a window frame carrying the window pane; and
a shim assembly coupled to the window frame, the shim assembly, comprising:
a first plate; and
a second plate movably coupled to the first plate; and
a wedge assembly operable to change a distance between the first plate and the second plate.

2. The apparatus of claim 1, wherein each of the first plate and the second plate, comprises:
a first end comprising a first inward tapered surface; and
a second end comprising a second inward tapered surface.

3. The apparatus of claim 2, wherein the wedge assembly, comprises:
a first wedge engaging the first inward tapered surfaces of the first plate and the second plate;
a second wedge engaging the second inward tapered surfaces of the first plate and the second plate; and
a fastener passing through the first wedge, between the first plate and the second plate, and threadably engaging the second wedge,
wherein rotating the fastener changes a distance between the first wedge and the second wedge and changes the distance between the first plate and the second plate.

4. The apparatus of claim 1, wherein the shim assembly comprises a guide that guides relative movement between the first plate and second plate.

5. The apparatus of claim 4, wherein the guide comprises corresponding structures that interact to guide relative movement between the first plate and the second plate.

6. The apparatus of claim 4, wherein the guide comprises ribs and grooves that receive one or more of the ribs.

7. The apparatus of claim 6, wherein the first plate comprises first plate ribs and a first plate groove, wherein the first plate groove is defined between a pair of the first plate ribs.

8. The apparatus of claim 6, wherein the second plate comprises a second plate rib and a second plate groove defined by the second plate rib.

9. The apparatus of claim 6, wherein the ribs and the grooves are positioned on either side of first inward tapered surfaces of the first plate and the second plate and the second inward tapered surfaces of the first plate and the second plate.

10. The apparatus of claim 6, wherein one or more of the ribs comprise a bevel.

11. The apparatus claim 1, wherein the first plate and the second plate comprise opposing surfaces that define a passage that is configured to receive a fastener.

12. The apparatus of claim 1, wherein the first plate and the second plate each comprise a central portion and side portions between which the central portion is positioned.

13. The apparatus of claim 12, wherein the side portions extend past the central portion on a first end of the first plate and the second plate and form a first end wedge guide and wherein the side portions extend past the central portion on a second end of the first plate and the second plate and form a second end wedge guide.

14. The apparatus of claim 13, wherein the first wedge interacts with the first end wedge guide to guide relative movement of the first wedge and the second wedge interacts with the second end wedge guide to guide relative movement of the second wedge.

15. The apparatus of claim 1, wherein the shim assembly comprises hinges that couple sides of the first plate and the second plate together.

16. The apparatus of claim 15, wherein the hinges comprise living hinges.

17. The apparatus of claim 1, wherein the first plate comprises a guide rib aperture and the second plate comprises a guide rib that is received by the guide rib aperture.

18. The apparatus of claim 1, wherein the second plate comprises an outward facing fastener.

19. The apparatus of claim 18, wherein the outward facing fastener comprises one or more spikes.

20. The apparatus of claim 19, wherein the outward facing fastener comprises adhesive.

21. An apparatus, comprising:
a shim assembly, comprising:
a first plate and a second plate movably coupled together, each of the first plate and the second plate, comprising:
a first end comprising a first inward tapered surface; and
a second end comprising a second inward tapered surface; and
a wedge assembly, comprising:
a first wedge engaging the first inward tapered surfaces of the first plate and the second plate;
a second wedge engaging the second inward tapered surfaces of the first plate and the second plate; and
a fastener passing through the first wedge, between the first plate and the second plate, and threadably engaging the second wedge,
wherein rotating the fastener changes a distance between the first wedge and the second wedge and changes a distance between the first plate and the second plate.

22. The apparatus of claim 21, wherein the first plate comprises an inward facing fastener.

23. The apparatus of claim 22, wherein the inward facing fastener comprises a U-shaped clip.

24. The apparatus of claim 23, wherein the U-shaped clip is configured to be coupled to a window frame or a door frame.

25. The apparatus of claim 21, further comprising a door panel and a door frame carrying the door panel, wherein the shim assembly is coupled to the door frame.

26. The apparatus of claim 21, further comprising a window pane and a window frame carrying the window pane, wherein the shim assembly is coupled to the window frame.

27. The apparatus of claim 21, wherein the second plate comprises an outward facing fastener.

28. The apparatus of claim 27, wherein the outward facing fastener comprises one or more spikes.

29. The apparatus of claim 21, wherein the shim assembly comprises a guide that guides relative movement between the first plate and second plate.

30. The apparatus of claim 29, wherein the guide comprises corresponding structures that interact to guide relative movement between the first plate and the second plate.

31.-42. (canceled)
